(19) United States
(12) Patent Application Publication
(10) Pub. No.: US 2003/0014308 A1
(43) Pub. Date: Jan. 16, 2003

(54) Method and apparatus for electronic commerce in electronic marketplace

(76) Inventors: Norio Takahashi, Yokohama (JP); Hiroshi Koike, Maehashi (JP); Makoto Takahashi, Yokohama (JP); Osamu Moriya, Yokohama (JP); Shuuichi Kawakita, Isehara (JP)

Correspondence Address: MATTINGLY, STANGER & MALUR P.C., SUITE 370, 1800 DIAGONAL ROAD, ALEXANDRIA, VA, 22314, US

(21) Appl. No.: 09/930,216

(22) Filed: Aug. 16, 2001

(30) Foreign Application Priority Data
Jul. 11, 2001 (JP) 2001-210145

(51) Int. Cl. G06F 17/60

(52) U.S. Cl. 705/14

(57) ABSTRACT

A selling terminal sends an enterprise ID and article detail information as article information together with allocation point information, and an electronic commerce system stores the article information and the allocation point information in correspondence with each other. A purchase terminal sends article information and transaction information as article transaction information, and the electronic commerce system stores the article transaction information. The electronic commerce system calculates a point number with reference to the enterprise ID and transaction information from the article transaction information, and stores the enterprise ID and the point number in correspondence with each other as point information. Referring to the allocation point information in correspondence with the article information, an incentive is provided to a seller enterprise by discounting an intermediation fee of the article transaction.

### BACKGROUND OF THE INVENTION

(i) Field of the Invention

The present invention relates to transaction techniques in electronic commerce utilizing networks.

(ii) Description of the Related Art

An e-market place (eMP), which is a virtual market for intermediating between a seller enterprise and a purchaser enterprise using an Internet technique, is starting to be used as a means for electronic commerce. An eMP manager enterprise provides a Web server and opens, on Internet, a catalog (the names of articles, appearance images, the prices, etc.) of articles that a seller enterprise wants to sell. A purchaser enterprise looks for an article to be purchased by the eMP and makes an order by the Web server. When receiving the order, the seller enterprise sends out the article and the purchaser enterprise pays the price. The eMP manager enterprise collects intermediation fees from the transaction participant enterprises. By many seller enterprises participating in the eMP, a price competition occurs, and the purchaser enterprise can purchase the article at a lower price. On the other hand, for the seller enterprise, by opening the catalog by the eMP, goods information can be provided to more latent purchaser enterprises.

Since the eMP manager enterprise gets intermediation fees as a principal income, the more the transaction participant enterprises are and the more the commerce quantity (an amount of money) is, the more the profit increases. Therefore, it is important for the eMP management to make an enterprise that continuously makes a large amount of commerce participate in the eMP for a long time.

In a general commerce, for making a continuous transaction with a customer, a seller performs giving of an incentive. For example, there is a method that points of about 3% the selling price are given to the customer and when the points are accumulated, a premium is presented in exchange for the points or a discount of the article selling price is performed in accordance with the points. By this, the purchase volition of the customer can be encouraged and the article can be purchased preferentially from the seller that gave the points. Such an incentive giving using points is utilized also in electronic commerce using Internet. For example, a patent “Point management method and implementing apparatus thereof and recording medium recording processing program thereof” (Japanese Patent Application Laid-open No. 2000-305984) describes a method of, when various enterprises respectively give the same customer points, integrally managing them. Besides, U.S. Patent “Method of redeeming collectible points” (U.S. Patent 6,178,408) describes a method of giving points to a customer that purchased an article and utilizing the points for a bidding of an auction.

Since articles transacted in the eMP are mainly materials required for an enterprise action such as direct materials and indirect materials, the transaction is a high price and if a breach of a transaction contract occurs, a large damage occurs. In the eMP, there may occur a breach of contracts with various frequencies and severenesses from impostures that an article is not sent out and the purchase price is not paid to a delay of the appointed date of delivery, a lack of quantity, a delivery of a defect article, a delay of the transfer of the price, an immediately before cancel of the execution of the contract.

To avoid the risk of such a nonfulfillment of a contract, the eMP adopts two methods. The first method is to prevent the occurrence of a nonfulfillment of a contract in each transaction. For example, there is even an eMP manager enterprise providing a service called Escrow in which the price from a purchaser enterprise is put in a banking organ as a third party and after confirming the delivery from a seller enterprise, a money transfer is performed. Besides, there is even a method of preventing a contract breach by providing a business firm function in which the eMP manager enterprise purchases goods from a seller enterprise and sells the goods to a purchaser enterprise.

The second method is to hold down the damage upon the occurrence of a contract breach to the minimum using an insurance or credit information. For example, there is an eMP which is in cooperation with a price payment service (buying of a credit; factoring) of a third party banking organ and makes the banking organ subrogate the risk of the price collection. Besides, an eMP manager enterprise accumulates part of an intermediation fee as an indemnity and performs a service of pay back upon a nonfulfillment of a contract.

A goods information intermediation type electronic commerce method provided by an eMP is performed in not only transactions between enterprises but also transactions for consumers. The most famous example of it is an auction utilizing Internet. For example, there is an auction provided by Yahoo Corporation. Such an auction is a service in which a general consumer can exhibit an article and a general consumer can bidding the article price. In such an auction, only a providing system of goods information and an auction type negotiation system are utilized by consumers and a service concerning an actual transaction (transmission/reception of the article, the price) is not performed. Therefore, the risk of a contract breach in a transaction as described above is all load on the transaction concerned parties (general consumers). To relieve this contract breach risk, in such an auction, an appraisal of an exhibitor is displayed together with information on the exhibited article. The appraisal of the exhibitor is made by pointing the transaction results that the exhibitor performed in the past. The calculation of points is performed as follows. Comments are sent by e-mails from transaction opposite parties of the exhibitor, the number of consumers who judge that the transaction was good (appropriate price, rapid response, sure delivery, etc.) and the number of those who judge that it was bad (exhibited article was inferior, the correspondence was bad, etc.) are displayed, and the difference between them is set at points.

### SUMMARY OF THE INVENTION

An eMP using the above prior art is being managed at present. However, in the eMP using the prior art, there is a problem that the eMP manager enterprise can not provide an incentive to a seller enterprise that continuously performs transactions. Besides, the seller enterprise can not obtain an incentive even if it continuously performs transactions in a specific eMP.

Besides, the seller enterprise can not set a contrast breach risk in relation to each article to be transacted in the eMP and show it to a purchaser enterprise. There is a problem that the purchaser enterprise can not know the contrast breach risk in relation to each article to be transacted in the eMP.

It is an object of the present invention to provide methods and systems in which an electronic commerce manager enterprise provides an incentive to a seller enterprise that performs a transaction in electronic commerce and the seller enterprise acquires the incentive in accordance with the transaction performed.

To improve the above problems, in the present invention, an enterprise ID and article detail information held by a selling terminal are sent to an electronic commerce system as article information, said electronic commerce system sends said article information to a purchase terminal, said article information and transaction information held by the purchase terminal are sent to said electronic commerce system as article transaction information, said electronic commerce system stores said article transaction information, calculates a point number with reference to the enterprise ID and the transaction information from said article transaction information, and stores said enterprise ID and said point number in correspondence with each other as point information, said selling terminal sends article information and allocation point information to said electronic commerce system, and said electronic commerce system stores said article information and said allocation point information in correspondence with each other, refers to article information from article transaction information, and calculates an intermediation fee of said article transaction with reference to allocation point information in correspondence with said article information.

Besides, to improve the above problems, in the present invention, an enterprise ID and article detail information held by a selling terminal are sent to an electronic commerce system as article information, said electronic commerce system sends said article information to a purchase terminal, said article information and transaction information held by the purchase terminal are sent to said electronic commerce system as article transaction information, said electronic commerce system stores said article transaction information, calculates a point number with reference to the enterprise ID and the transaction information from said article transaction information, and stores said enterprise ID and said point number in correspondence with each other as point information, said selling terminal sends article information and allocation point information to said electronic commerce system, and said electronic commerce system stores said article information and said allocation point information in correspondence with each other, refers to article information from article transaction information, and calculates a indemnity fee of said article transaction with reference to allocation point information in correspondence with said article information.

### BRIEF DESCRIPTION OF THE DRAWINGS

FIG. 1 is a data flow chart between transaction participators to which the first embodiment is applied;

FIG. 2 is a diagram showing a detailed construction of an eMP system to which the second embodiment is applied;

FIG. 3A is a representation showing a detail of an article management table to which the second embodiment is applied;

FIG. 3B is a representation showing a detail of a commerce management table to which the second embodiment is applied;

FIG. 3C is a representation showing a detail of a point management table to which the second embodiment is applied;

FIG. 4 is a chart showing a processing flow of an article registration module in the second embodiment;

FIG. 5 is a chart showing a processing flow of a point allocation module in the second embodiment;

FIG. 6 is a chart showing a processing flow of a fee management module in the second embodiment;

FIG. 7 is a chart showing a processing flow of a indemnity fee management module in the third embodiment;

FIG. 8 is a representation showing allotments of a indemnity fee in the fourth embodiment;

FIG. 9 is a view showing a WWW browser window for displaying article information in the fifth embodiment;

FIG. 10 is a view showing a WWW browser window for displaying point information in the fifth embodiment; and

FIG. 11 is a view showing a WWW browser window for an operation of allocating points to article information in the sixth embodiment.

### DETAILED DESCRIPTION OF THE EMBODIMENTS

Examples of embodiments of the present invention will be described with reference to drawings.

The object is to provide a method and a system in which an electronic commerce manager enterprise provides an incentive to a seller enterprise that performs a transaction in electronic commerce and the seller enterprise acquires the incentive in accordance with the transaction performed, the seller enterprise sets a contrast breach risk in relation to each article to be transacted in the electronic commerce and shows it to a purchaser enterprise, and the purchaser enterprise acquires said contrast breach risk.

In the first embodiment, an embodiment of a principle of the present invention will be shown.

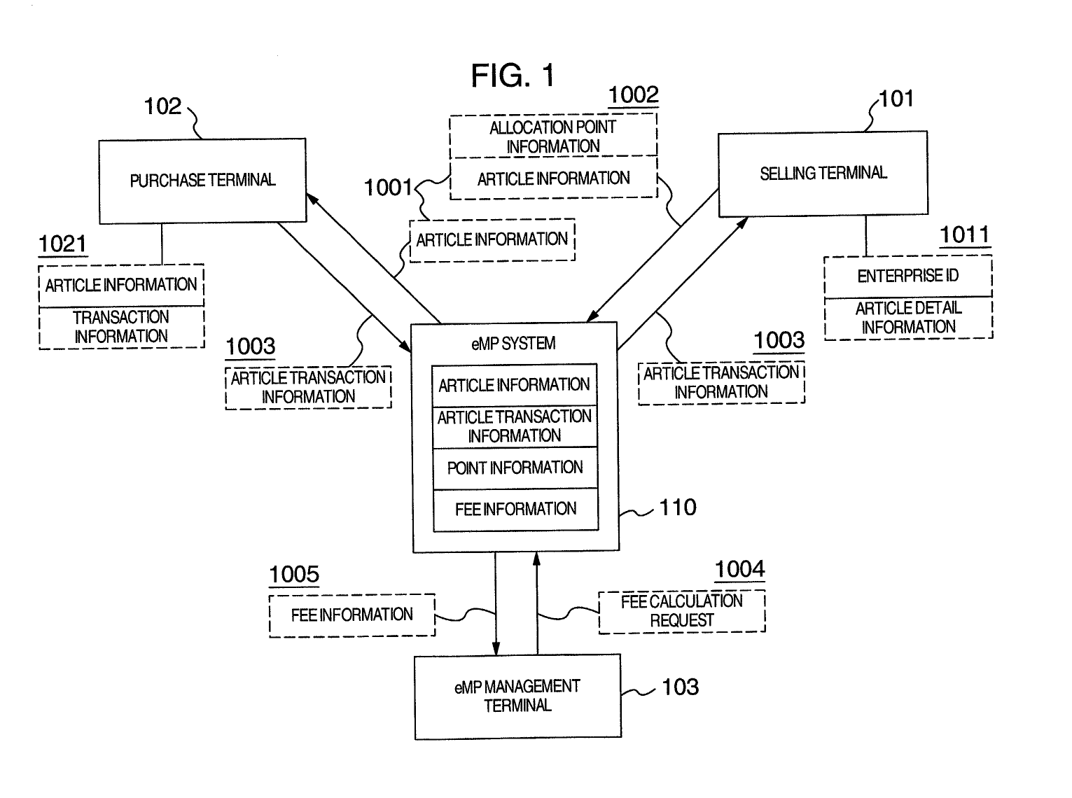

FIG. 1 is a data flow chart between transaction participators to which the first embodiment is applied. A selling terminal 101, a purchase terminal 102, and an eMP management terminal 103 are terminals that communicates with an eMP system 110. The eMP system 110 is a system for providing an eMP function. The selling terminal 101 has data 1011 having enterprise IDs and article detail information. The purchase terminal 102 has data 1021 having article information and transaction information. The eMP system 110 has article information, article transaction information, point information, and fee information. Article information 1001 is data that the selling terminal 101 sends to the eMP system 110 and the eMP system 110 sends to the purchase terminal 102. Allocation point information 1002 is data that the selling terminal 101 sends to the eMP system 110. Article transaction information 1003 is data that the purchase terminal 102 sends to the eMP system 110 and the eMP system 110 sends to the selling terminal 101. A fee calculation notification 1004 is data that the eMP management terminal 103 sends to the eMP system 110. Fee information 1005 is data that the eMP system 110 sends to the eMP management terminal 103.

A processing flow in the first embodiment will be described below. Using the selling terminal 101, a user belonging to an enterprise that is to sell an article sends the article information 1001 having an enterprise ID and article detail information stored in the selling terminal 101, and the allocation point information 1002 to the eMP system 110. The eMP system 110 stores the article information 1001 and the allocation point information 1002 in correspondence with each other.

Using the purchase terminal 102, a user belonging to an enterprise that is to purchase the article requests the eMP system 110 to transmit the article information 1001. The eMP system 110 sends said article information 1001 to the purchase terminal 102. The purchase terminal 102 stores the said article information 1001 received. The user of said purchaser enterprise peruses the article information 1001 stored in the purchase terminal 102, and sends the article information 1001 on an article to be purchased and transaction information for ordering the article as article transaction information 1003 from the purchase terminal 102 to the eMP system 110. The eMP system 110 stores the article transaction information 1003.

Using the selling terminal 101, the user of said seller enterprise requests the eMP system 110 to transmit the article transaction information 1003, and the eMP system 110 sends said article transaction information 1003 to the selling terminal 101. The user of said seller enterprise peruses said article transaction information 1003 in the selling terminal 101, and knows that said purchaser enterprise has ordered the article. Said seller enterprise sends the article to the purchaser enterprise on the basis of said transaction information. The purchaser enterprise confirms the reception of said article and pays the price to said seller enterprise.

Using the eMP management terminal 103, a user belonging to the eMP manager enterprise sends a fee calculation request 1004 to the eMP system 110. The eMP system 110 refers to transaction information from the article transaction information 1003 and calculates an increase point number. It refers to the article information 1001 from the article transaction information 1003 and refers to the allocation point information 1002 in correspondence with said article information 1001. The eMP system 110 refers to an enterprise ID from said article information 1001 and refers to point information in correspondence with said enterprise ID. It adds said increase point number to said point information, subtracts the allocation point information 1002, and stores the calculated point information in correspondence with said enterprise ID.

Further, the eMP system 110 calculates a fee discount amount on the basis of said allocation point information 1002, and calculates a fee amount by subtracting said fee discount amount from an existing fee amount. The eMP system 110 sends said fee amount to the eMP management terminal 103 as fee information 1005. The user of said eMP manager enterprise purses the fee information 1005 in the eMP management terminal 103, and make a fee payment demand based on the fee information 1005 to the seller enterprise. The seller enterprise having received the fee payment demand pays the fee.

By performing the above process, since the profit of the seller enterprise can be increased by discounting the fee in one article transaction, the eMP manager enterprise can give an incentive to the seller enterprise that continuously performs transactions. Besides, since points given in accordance with the transaction are allocated to each article transaction and the profit can be increased by discounting the fee, the seller enterprise can obtain an incentive by continuously performing transactions in the eMP.

In the second embodiment, a detailed embodiment in which the present invention is applied to an eMP system will be shown.

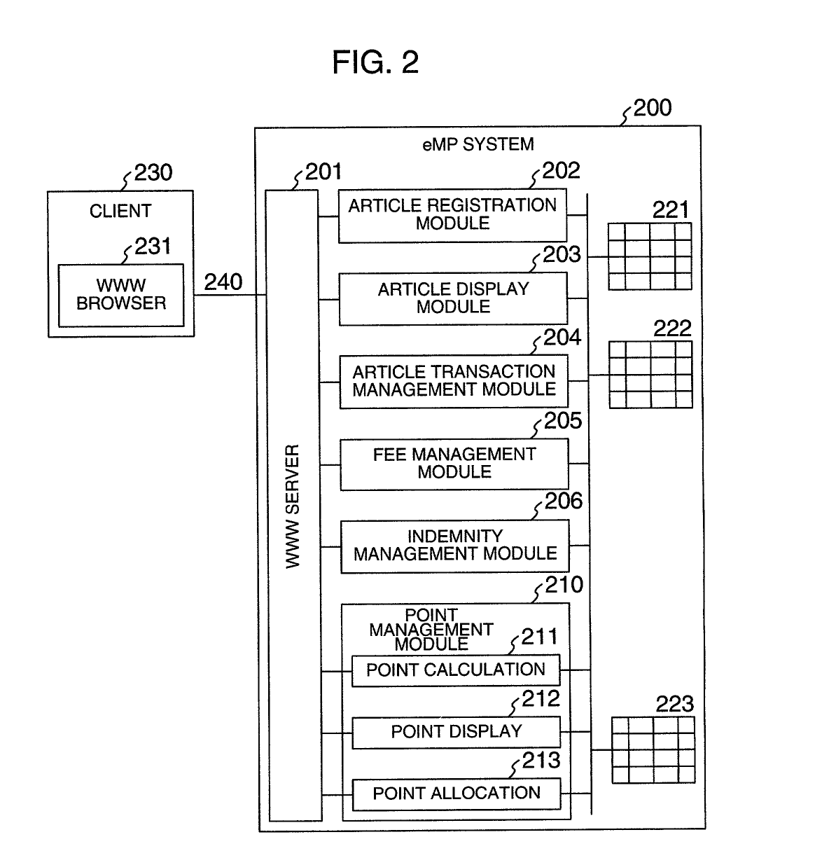

FIG. 2 is a diagram showing a detailed construction of an eMP system to which the second embodiment is applied. The eMP system 200 has a WWW server 201, an article registration module 202, an article display module 203, an article transaction management module 204, a fee management module 205, a indemnity fee management module 206, a point management module 210, an article management table 221, an article transaction management table 222, and a point management table 223. The point management module 210 has a point calculation module 211, a point display module 212, and a point allocation module 213. A client computer 230 has a WWW browser 231. The eMP system 200 and the client computer 230 are connected with each other through a network 240. The WWW server 201 is a program for receiving a processing request from the WWW browser 231 transmitted through the network 240, accessing the article registration module 202, the article display module 203, the article transaction management module 204, the fee management module 205, the indemnity fee management module 206, and the point management module 210, and sending the result to the WWW browser 231. The article registration module 202 is a program for receiving a request of the WWW server 201 and writing article information and allocation point information to the article management table 221. The article display module 203 is a program for receiving a request of the WWW server 201, searching the article management table 221, and returning requested article information. The article transaction management module 204 is a program for receiving a request of the WWW server 201 and writing a transaction state to the article transaction management table 222. The fee management module 205 is a program for receiving a request of the WWW server 201, searching the article transaction management table 222, calculating a fee amount of a requested transaction, and returning the value. The indemnity fee management module 206 is a program for receiving a request of the WWW server 201, searching the article transaction management table 222, calculating a indemnity fee amount of a requested transaction, and returning the value. The point management module 210 is a program for receiving a request of the WWW server 201 or another module and managing the point management table 223. The point calculation module 211 is a program for receiving a request from the point management module 210, calculating points from a designated transaction quantity, increasing/decreasing the points of a designated enterprise, and writing it to the point management table 223. The point display module 212 is a program for receiving a request from the point management module 210, retrieving point information on a designated enterprise from the point management table 223, and returning it. The point allocation module 213 is a program for receiving a request from the point management module 210, decreasing the point of a designated enterprise by a designated amount, and writing it to the point management table 223. The article management table 221 is a table for keeping information on articles to be sold. The article transaction management table 222 is a table for keeping states and a history of transactions. The point management table 223 is a table for keeping points. The WWW browser 231 is a program for transmitting a request to the WWW server 201 through the network 240, receiving a reply, and displaying it on a screen.

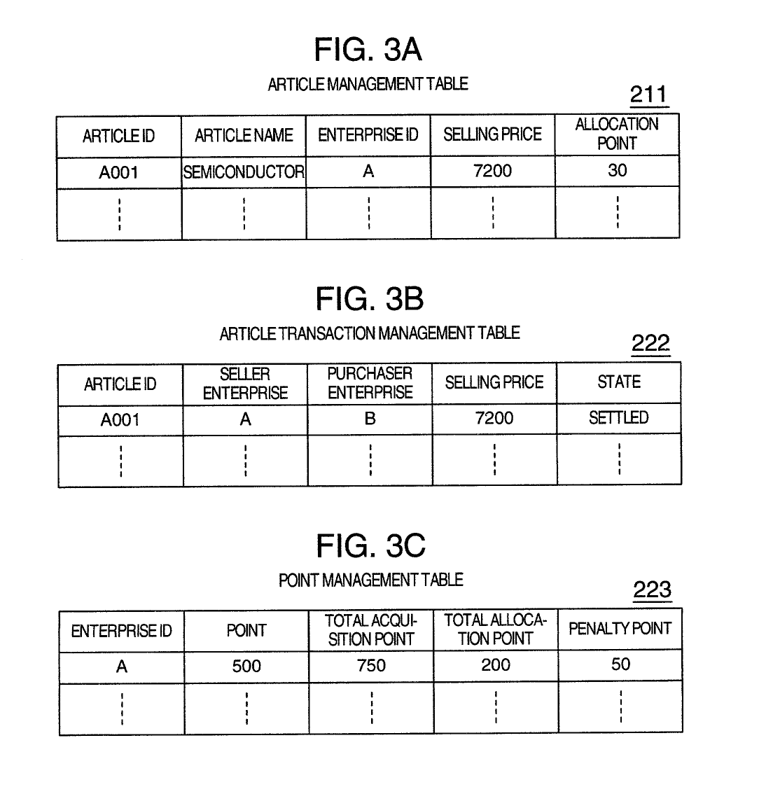

FIGS. 3A to 3C are representations showing details of the respective management tables.

The article management table 221 has items for recording article IDs, items for recording article names, items for recording seller enterprise IDs, items for recording selling prices, and items for recording allocation points.

The article transaction management table 222 has items for recording article IDs, items for recording seller enterprise IDs, items for recording purchaser enterprise IDs, items for recording selling prices, and items for recording transaction states.

The point management table 223 has items for recording enterprise IDs, items for recording current points, items for recording total acquisition points, items for recording total allocation points, and items for recording penalty points.

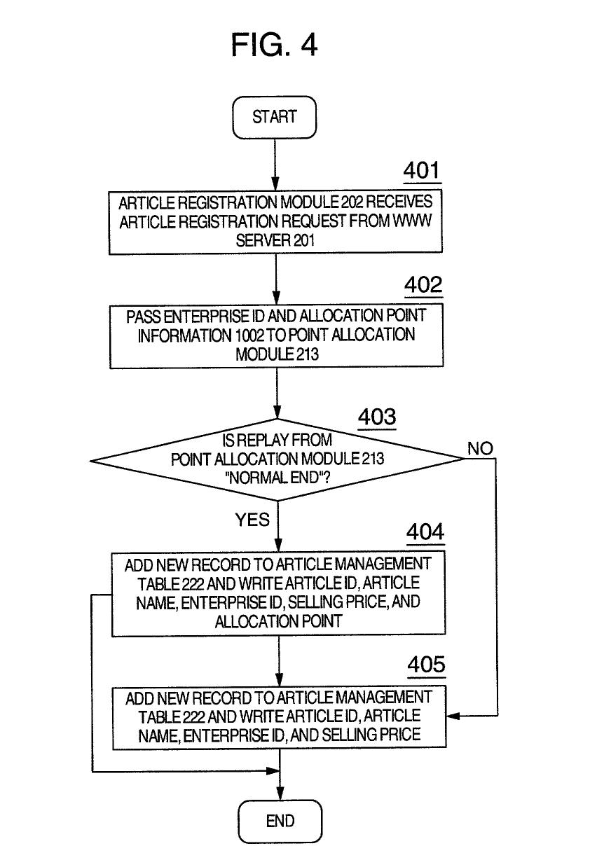

FIG. 4 is a chart showing a processing flow of the article registration module 202 in this embodiment.

A user belonging to an enterprise that is to sell an article operates the WWW browser 231 and transmits, to the WWW server 201, the enterprise ID of the seller enterprise, the article information 1001 having the enterprise name, the article ID, the article name, and the selling price, and the allocation point information 1002 having a point number to be allocated when the article is sold. The WWW server 201 having received the request passes the article information 1001 and the allocation point information 1002 to the article registration module 202. The article registration module 202 executes processing from step 401 to step 404. Step 401 is a step in which the article registration module 202 receives an article registration request from the WWW server 201. Step 402 is a step of passing said enterprise ID and said allocation point information 1002 to the point allocation module 213. Step 403 is a step of judging as to whether a reply from the point allocation module 213 is “normal end”. When the reply from the point allocation module 213 is “normal end”, step 404 is executed. Step 404 is a step of adding a new record to the article management table 222, and writing the article ID, the article name, the enterprise ID, the selling price, and the allocation point. If the reply from the point allocation module 213 is “allocation impossible”, step 405 is executed. Step 405 is a step of adding a new record to the article management table 222, and writing the article ID, the article name, the enterprise ID, and the selling price. After executing step 404 or 405, the flow ends.

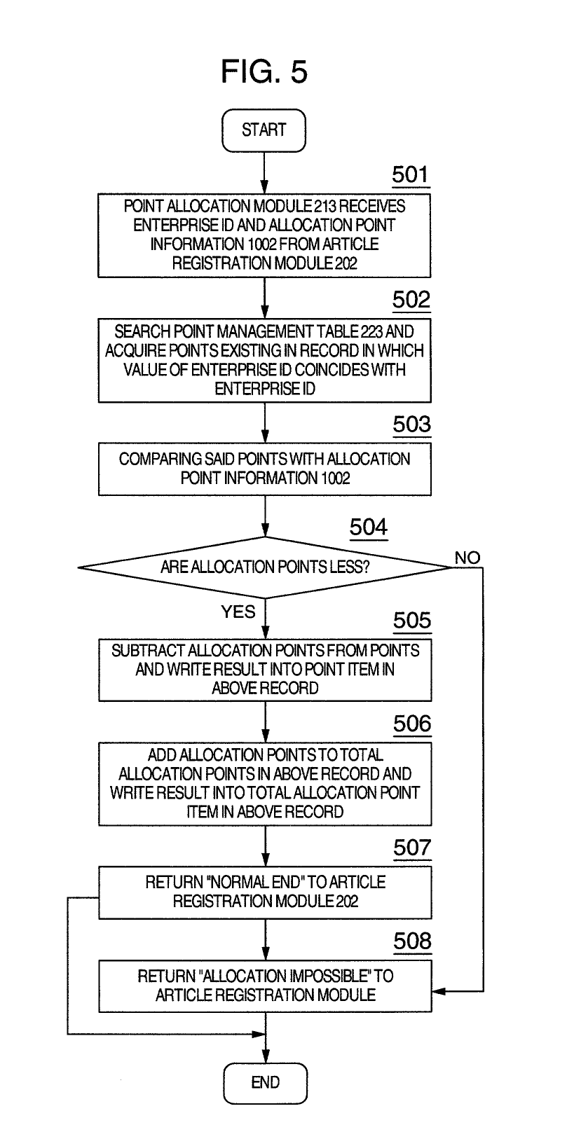

FIG. 5 is a chart showing a processing flow of the point allocation module 213 in this embodiment. The point allocation module 213 executes processing from step 501 to step 508. Step 501 is a step in which the point allocation module 213 receives an enterprise ID and said allocation point information 1002 from the article registration module 202. Step 502 is a step of searching the point management table 223 and acquiring points existing in a record in which the value of the enterprise ID coincides with said enterprise ID. Step 503 is a step of comparing the acquired points with said allocation point information 1002. Step 504 is a step of executing step 505 when said allocation point information 1002 is less, and executing step 508 when it is more. Step 505 is a step of subtracting said allocation point information 1002 from the acquired points, and writing the result to a point item in said record. Step 506 is a step of adding allocation points to the total allocation points in said record, and writing the result to a total allocation point item in said record. Step 507 is a step of returning “normal end” to the article registration module 202. Step 508 is a step of returning “allocation impossible” to the article registration module 202.

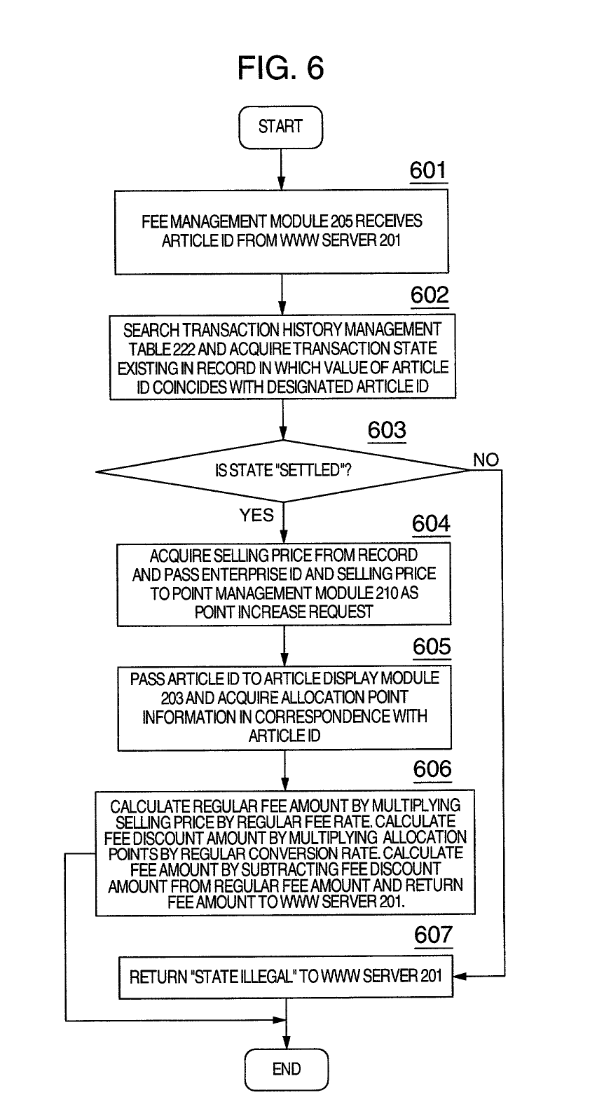

FIG. 6 is a chart showing a processing flow of the fee management module 205 in this embodiment. A user belonging to the eMP manager enterprise operates the WWW browser 231 and transmits, to the WWW server 201, a fee calculation request 1004 having an article ID of a transaction for which the fee is to be calculated. The WWW server 201 having received the request passes said article ID to the fee management module 205. The fee management module 205 executes processing from step 601 to step 607. Step 601 is a step in which the fee management module 205 receives said article ID from the WWW server 201. Step 602 is a step of searching the article transaction management table 222 and acquiring a transaction state existing in a record in which the value of the article ID coincides with the designated article ID. Step 603 is a step of judging as to whether or not the acquired state is “settled”, executing step 604 when it is “settled”, and executing step 607 if it is not “settled”. Step 604 is a step of acquiring the selling price from said record, and passing said enterprise ID and said selling price to the point management module 210 as a point increase request. Step 605 is a step of passing said article ID to the article display module 203 and acquiring the allocation point information in correspondence with said article ID. Step 606 calculates a regular fee amount by multiplying said selling price by a regular fee rate. It calculates a fee discount amount by multiplying said allocation points by a regular conversion rate. It is a step of calculating a fee amount by subtracting said fee discount amount from said regular fee amount, and returning the fee amount to the WWW server 201. Step 607 is a step of returning “state illegal” to the WWW server 201. The WWW server 201 having received the reply from the fee management module 205 returns the reply to the WWW browser 231.

The point management module 210 having received the enterprise ID and the selling price as a point increase request passes said enterprise ID and said selling price to the point calculation module 211. The point calculation module 211 searches the point management table 223 and acquires points existing in a record in which the enterprise ID coincides with said enterprise ID, and the total acquisition points. It calculates an increase point number by multiplying said selling price by a regular conversion rate. It adds said increase point number to either of said points and said total acquisition points, and writes them to a point item and a total acquisition point item in said record.

The article display module 203 having received the article ID searches the article management table 221 and acquires allocation points existing in a record in which the article ID coincides with said article ID. The article display module 203 returns said allocation points to the fee management module 205.

By performing the above process, since the profit of the seller enterprise can be increased by discounting the fee in one article transaction, the eMP manager enterprise can give an incentive to the seller enterprise that continuously performs transactions. Besides, since points given in accordance with the transaction are allocated to each article transaction and the profit can be increased by discounting the fee, the seller enterprise can obtain an incentive by continuously performing transactions in the eMP.

In the third embodiment, an embodiment in which allocation points and a transaction indemnity fee are linked will be shown.

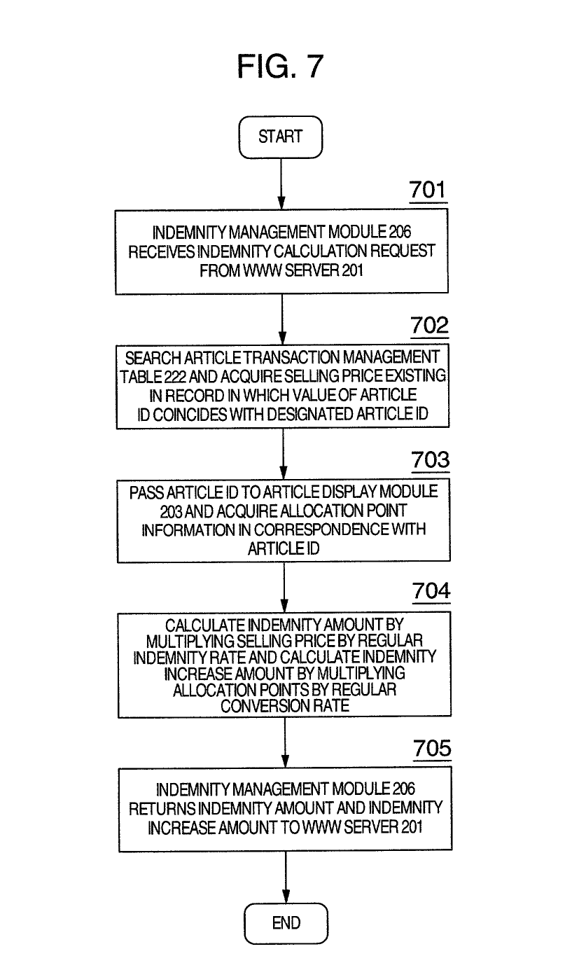

FIG. 7 is a chart showing a processing flow As of the indemnity fee management module 206 in this embodiment.

If a breach of a transaction contract occurs, a user belonging to the eMP manager enterprise operates the WWW browser 231 and transmits, to the WWW server 201, the article ID of a transaction for which the indemnity fee is to be calculated. The WWW server 201 having received the request passes the article ID to the indemnity fee management module 206. The indemnity fee management module 206 executes processing from step 701 to step 705. Step 701 is a step in which the indemnity fee management module 206 receives the indemnity fee calculation request from the WWW server 201. Step 702 is a step of searching the article transaction table 222 and acquiring a selling price existing in a record in which the article ID coincides with the designated article ID. Step 703 is a step of passing said article ID to the article display module 203 and acquiring the allocation point information in correspondence with said article ID. Step 704 is a step of calculating a indemnity fee amount by multiplying said selling price by a regular indemnity fee rate, and further calculating a indemnity fee increase amount by multiplying said allocation points by a regular conversion rate. Step 705 is a step in which the indemnity fee management module 206 returns the indemnity fee amount and the indemnity fee increase amount to the WWW server 201. The WWW server 201 having received the reply from the indemnity fee management module 206 returns the reply to the WWW browser 231.

The eMP manager enterprise pays, to the purchaser enterprise, the total indemnity fee amount calculated by adding the indemnity fee increase amount to the indemnity fee amount acquired.

By performing the above process, the eMP manager enterprise can provide an incentive of risk avoidance to the seller enterprise that allocated points.

In the fourth embodiment, an embodiment in which allocation points are used in a fee calculation and a indemnity fee calculation will be shown.

By the first, second, and third embodiments, the eMP manager enterprise can provide an incentive to the seller enterprise. In the above-described embodiments, however, since a profit is produced only when the seller enterprise allocated points, the seller enterprise always intends to allocate points, so the profit of the eMP manager enterprise decreases. In this embodiment, an incentive is provided also to a seller enterprise that does not allocate points, and thereby the profit of the eMP manager enterprise is ensured.

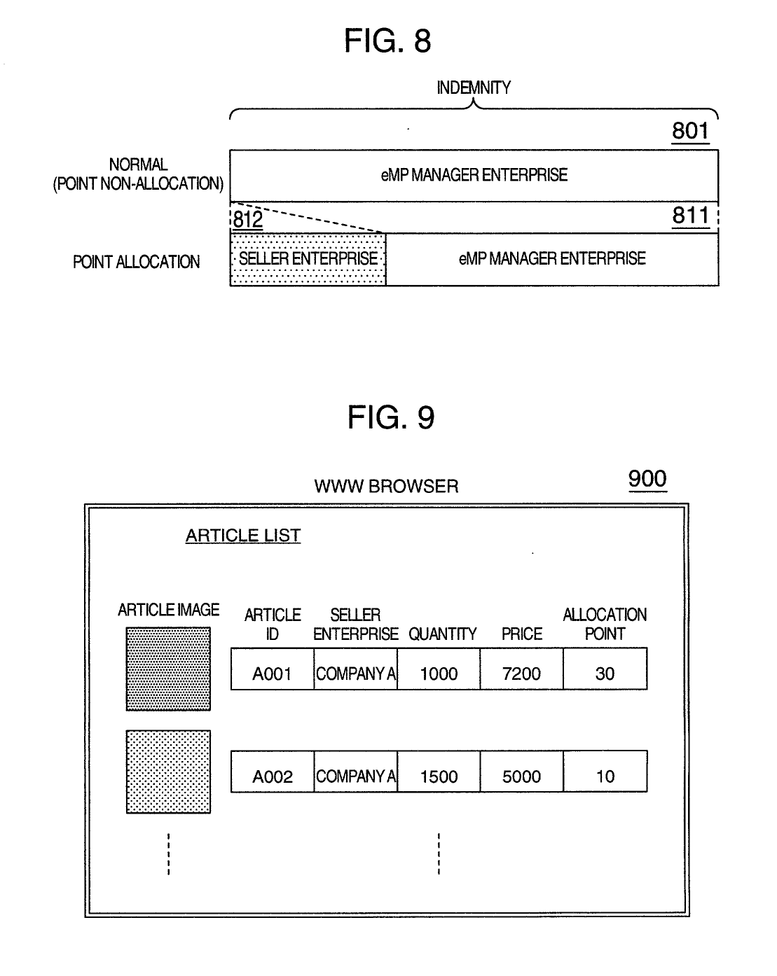

FIG. 8 is a representation showing allotments of a indemnity fee in this embodiment.

After a seller enterprise makes an article transaction contract with a purchaser enterprise, if the seller enterprise did a breach act such as the transaction cancel, the eMP manager enterprise pays, to the purchaser enterprise, a indemnity fee in accordance with the transaction amount of money. In that transaction, if the seller enterprise did not allocate points, the eMP manager enterprise pays the full amount of indemnity fee 801. On the other hand, when the seller enterprise has allocated points, the seller enterprise pays a indemnity immunity amount 812 in accordance with the allocation points and the eMP manager enterprise pays a indemnity reduction and exemption amount 811.

The eMP manager enterprise executes the second embodiment. And, upon the occurrence of a breach, it executes the third embodiment and acquires a indemnity amount and a indemnity increase amount from the eMP system 110. The eMP manager enterprise considers said indemnity increase amount the indemnity immunity amount and pays, to the purchase enterprise, the indemnity reduction and exemption amount calculated by subtracting the indemnity immunity amount from said indemnity amount. Besides, it demands the seller enterprise to pay the indemnity immunity amount to the purchaser enterprise. The seller enterprise demanded to pay pays the indemnity immunity amount to the purchaser enterprise.

By performing the above process, the eMP manager enterprise can provide an incentive of fee discount to the seller enterprise that allocated points, and can provide an incentive of risk avoidance to the seller enterprise 101 that did not allocated points. By providing the incentive to the seller enterprise 101 that did not allocated points, points are prevented from being one-sidedly allocated and a profit decrease per one transaction of the eMP manager enterprise 100 can be prevented.

In the fifth embodiment, an embodiment in which allocation points are displayed in correspondence with article information will be shown.

Hereinafter, a flow of processing for displaying article information and allocation point information will be described. A user belonging to an enterprise that is to purchase an article operates the WWW browser 231 and transmits an information display request on an article to be purchased, to the WWW server 201 through the network 240. When receiving the request, the WWW server 201 passes the article information display request to the article display module 203. When receiving the article information display request from the WWW server 201, the article display module 203 searches the article management table 221 and acquires allocation points together with article information such as the article name, the seller enterprise ID, the seller enterprise name, the selling quantity, the selling price, the article image, and so on, existing in a record in which the value of the article ID coincides with the designated article ID. The article display module 203 returns the acquired information to the WWW server 201, and the WWW server 201 transmits said information to the WWW browser 231.

FIG. 9 is a view showing a WWW browser window for displaying article information in this embodiment. In addition to article information such as the article ID, the seller enterprise name, the selling quantity, the selling price, the article image, and so on, the WWW browser window 900 shows points that the seller enterprise allocates in relation to this article transaction, in correspondence.

Hereinafter, a flow of processing for displaying point information will be described. A user belonging to an enterprise that is to purchase an article operates the WWW browser 231 and transmits an information display request on points to the WWW server 201 through the network 240. When receiving the request, the WWW server 201 passes the point information display request to the point management module 210. When receiving the request, the point management module 210 passes the point information display request to the point display module 212. When receiving the point information display request from the point management module 210, the point display module 212 searches the point management table 223 and acquires the enterprise ID, the enterprise name, the current points, the total acquisition points, the total allocation points, and penalty points existing in a record in which the enterprise ID coincides with the designated conditions. The point display module 212 returns the acquired information to the point management module 210, the point management module 210 returns said information to the WWW server 201, and the WWW server 201 transmits said information to the WWW browser 231.

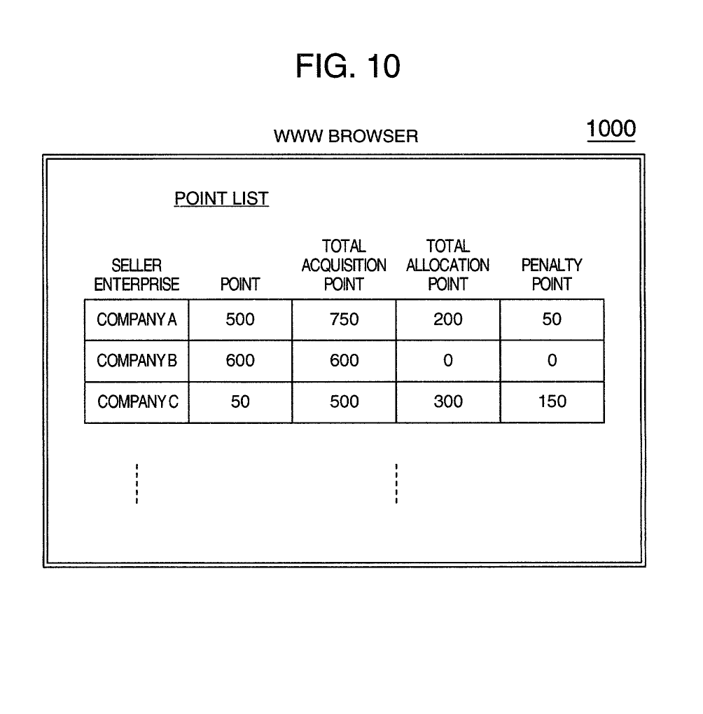

FIG. 10 is a view showing a WWW browser window for displaying point information in this embodiment.

The WWW browser window 1000 shows the enterprise name, the current points, the total acquisition points, the total allocation points, and the penalty points.

By performing the above process, the eMP manager enterprise can clearly show a risk of the article transaction to the purchaser enterprise. The purchaser enterprise can manage the risk of the article transaction by comparing the price with the allocation points displayed for each article.

In the sixth embodiment, an embodiment of an operation window for allocating points to article information will be shown.

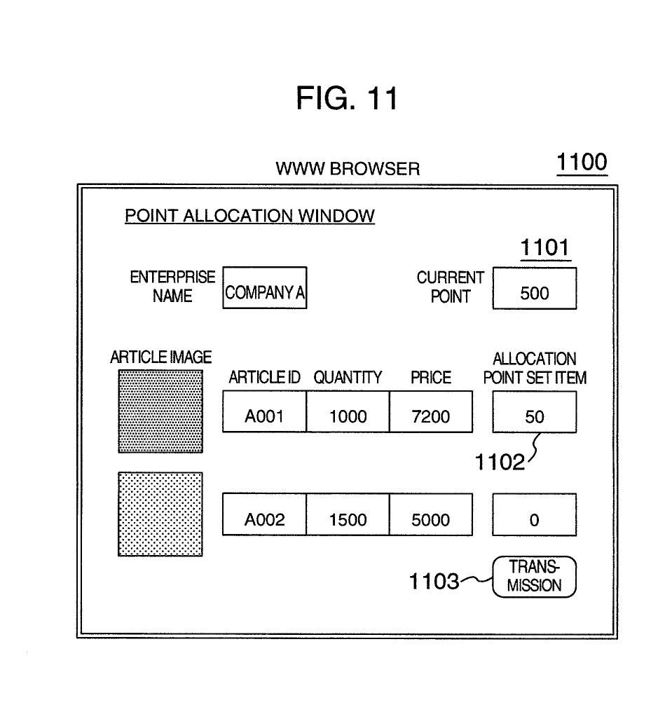

FIG. 11 is a view showing a WWW browser window for an operation of allocating points to article information in this embodiment.

The WWW browser window 1100 displays said enterprise name acquired from the eMP system, the current points 1101, and the article ID, and shows article information such as the selling quantity, the selling price, the article image, and so on. An allocation point set item 1102 is an item for entering the value of allocation points in correspondence with each article information. A transmission button 1103 is an icon for, when being clicked, requesting the WWW browser 231 to transmit said information.

A user belonging to an enterprise that is to sell an article operates the WWW browser 231 and transmits a point allocation operation request to the WWW server 201 through the network 240. When receiving the request, the WWW server 201 passes the point allocation operation request to the article registration module 202. When receiving the request, the article registration module 202 passes a point information display request to the point management module 210. When receiving the request, the point management module 210 passes the point information display request to the point display module 212. When receiving the point information display request from the point management module 210, the point display module 212 searches the point management table 222 and acquires the enterprise name and the current points existing in a record in which the enterprise name coincides with the designated enterprise name. The point display module 212 returns the acquired information to the point management module 210, and the point management module 210 returns said information to the article registration module 202.

Next, the article registration module 202 passes an article information display request to the article display module 203. When receiving the request, the article display module 203 searches the article management table 222 and acquires allocation points together with article information such as the article ID, the article name, the seller enterprise name, the selling quantity, the selling price, the article image, and so on, existing in a record in which the seller enterprise name coincides with the designated enterprise name. The article display module 203 returns the acquired information to the article registration module 202.

The article registration module 202 returns the acquired point information and article information to the WWW server 201, and the WWW server 201 transmits said information to the WWW browser 231. The WWW browser 231 displays the browser window 1100.

When the user of said seller enterprise rewrites the allocation points displayed in the allocation point set item 1102, the current points 1101 are updated and re-displayed. When clicking the transmission button 1103, it is transmitted to the WWW server 201 as said enterprise ID, article information having the enterprise name, the article ID, the article name, and the selling price, and allocation point information.

By performing the above process, the seller enterprise 101 can set the value of allocation points 1102 with referring to the current points 1101.

By the above, it becomes possible to provide a method and a system in which the eMP manager enterprise provides an incentive to the seller enterprise that performs transactions by eMP, and the seller enterprise acquires an incentive in accordance with the transaction performed.

Besides, it becomes possible that the seller enterprise sets a contract breach risk in relation to each article to be transacted by eMP, and provides it to the purchaser enterprise, and the purchaser enterprise acquires said contract breach risk.

By the electronic commerce manager enterprise providing an incentive to the seller enterprise that performs transactions by electronic commerce, the seller enterprise can acquire the incentive in accordance with the transaction performed.

What is claimed is:

1. An electronic commerce method comprising the steps of:
in case of inputting a held enterprise ID and article detail information from a selling terminal as article information, sending said article information to a purchase terminal, inputting said article information and transaction information from the purchase terminal as article transaction information and storing said article transaction information, calculating a point number with reference to the enterprise ID and transaction information from said article transaction information, and storing said enterprise ID and said point number in correspondence with each other as point information;
inputting article information and allocation point information from said selling terminal; and
storing said article information and said allocation point information in correspondence with each other, referring to article information from said article transaction information, and calculating an intermediation fee of said article transaction with reference to allocation point information in correspondence with said article information.

2. An electronic commerce method comprising the steps of:
in case of inputting a held enterprise ID and article detail information from a selling terminal as article information, sending said article information to a purchase terminal, inputting said article information and transaction information from the purchase terminal as article transaction information and storing said article transaction information, calculating a point number with reference to the enterprise ID and transaction information from said article transaction information, and storing said enterprise ID and said point number in correspondence with each other as point information;
inputting article information and allocation point information from said selling terminal; and
storing said article information and said allocation point information in correspondence with each other, referring to article information from said article transaction information, and calculating a indemnity fee of said article transaction with reference to allocation point information in correspondence with said article information.

3. The method according to claim 1, wherein said electronic commerce system refers to said article information from article transaction information, and calculates a indemnity fee of said article transaction with reference to said allocation point information.

4. The method according to claim 1, further comprising the steps of:
inputting an article information display request from said purchase terminal; and
sending, to said purchase terminal, said article information and allocation point information in correspondence with said article information,
wherein said purchase terminal displays said article information and said allocation point information in correspondence with each other.

5. The method according to claim 2, further comprising the steps of:
inputting an article information display request from said purchase terminal; and
sending, to said purchase terminal, said article information and allocation point information in correspondence with said article information,
wherein said purchase terminal displays said article information and said allocation point information in correspondence with each other.

6. The method according to claim 3, further comprising the steps of:
inputting an article information display request from said purchase terminal; and
sending, to said purchase terminal, said article information and allocation point information in correspondence with said article information,
wherein said purchase terminal displays said article information and said allocation point information in correspondence with each other.

7. The method according to claim 1, further comprising the steps of:
inputting a held enterprise ID and a point allocation operation request from the selling terminal; and
sending, to said selling terminal, point information in correspondence with said enterprise ID, article information in correspondence with said enterprise ID, and allocation point information,
wherein said selling terminal displays, on a screen, said point information and said allocation point information in correspondence with said article information,
and said method further comprises the step of inputting, from said selling terminal, said article information and allocation point information input to the terminal.

8. The method according to claim 2, further comprising the steps of:
inputting a held enterprise ID and a point allocation operation request from the selling terminal; and
sending, to said selling terminal, point information in correspondence with said enterprise ID, article information in correspondence with said enterprise ID, and allocation point information,
wherein said selling terminal displays, on a screen, said point information and said allocation point information in correspondence with said article information,
and said method further comprises the step of inputting, from said selling terminal, said article information and allocation point information input to the terminal.

9. The method according to claim 3, further comprising the steps of:
inputting a held enterprise ID and a point allocation operation request from the selling terminal; and
sending, to said selling terminal, point information in correspondence with said enterprise ID, article information in correspondence with said enterprise ID, and allocation point information,
wherein said selling terminal displays, on a screen, said point information and said allocation point information in correspondence with said article information,
and said method further comprises the step of inputting, from said selling terminal, said article information and allocation point information input to the terminal.

10. An electronic commerce apparatus comprising:
in case of inputting a held enterprise ID and article detail information from a selling terminal as article information, means for sending said article information to a purchase terminal, and means for inputting said article information and transaction information from the purchase terminal as article transaction information and storing said article transaction information, calculating a point number with reference to the enterprise ID and transaction information from said article transaction information, and storing said enterprise ID and said point number in correspondence with each other as point information;
means for inputting article information and allocation point information from said selling terminal; and
means for storing said article information and said allocation point information in correspondence with each other, referring to article information from said article transaction information, and calculating an intermediation fee of said article transaction with reference to allocation point information in correspondence with said article information.

11. An electronic commerce apparatus comprising:
in case of inputting a held enterprise ID and article detail information from a selling terminal as article information, means for sending said article information to a purchase terminal, and means for inputting said article information and transaction information from the purchase terminal as article transaction information and storing said article transaction information, calculating a point number with reference to the enterprise ID and transaction information from said article transaction information, and storing said enterprise ID and said point number in correspondence with each other as point information;
means for inputting article information and allocation point information from said selling terminal; and
means for storing said article information and said allocation point information in correspondence with each other, referring to article information from said article transaction information, and calculating a indemnity fee of said article transaction with reference to allocation point information in correspondence with said article information.

12. An electronic commerce program comprising:
in case of inputting a held enterprise ID and article detail information from a selling terminal as article information, the step of sending said article information to a purchase terminal, and the step of inputting said article information and transaction information from the purchase terminal as article transaction information and storing said article transaction information, calculating a point number with reference to the enterprise ID and transaction information from said article transaction information, and storing said enterprise ID and said point number in correspondence with each other as point information;
the step of inputting article information and allocation point information from said selling terminal; and
the step of storing said article information and said allocation point information in correspondence with each other, referring to article information from said article transaction information, and calculating an intermediation fee of said article transaction with reference to allocation point information in correspondence with said article information.

13. An electronic commerce program comprising:
in case of inputting a held enterprise ID and article detail information from a selling terminal as article information, the step of sending said article information to a purchase terminal, and the step of inputting said article information and transaction information from the purchase terminal as article transaction information and storing said article transaction information, calculating a point number with reference to the enterprise ID and transaction information from said article transaction information, and storing said enterprise ID and said point number in correspondence with each other as point information;
the step of inputting article information and allocation point information from said selling terminal; and
the step of storing said article information and said allocation point information in correspondence with each other, referring to article information from said article transaction information, and calculating a indemnity fee of said article transaction with reference to allocation point information in correspondence with said article information.
